(19) United States
(12) Patent Application Publication
(10) Pub. No.: US 2014/0019738 A1
(43) Pub. Date: Jan. 16, 2014

(54) MULTICORE PROCESSOR SYSTEM AND BRANCH PREDICTING METHOD

(71) Applicant: FUJITSU LIMITED, Kawasaki-shi (JP)

(72) Inventors: Akihito KATAOKA, Hamura (JP); Atsuhiro SUGA, Tokorozawa (JP)

(73) Assignee: FUJITSU LIMITED, Kawasaki-shi (JP)

(21) Appl. No.: 14/029,511

(22) Filed: Sep. 17, 2013

Related U.S. Application Data
(63) Continuation of application No. PCT/JP2011/056659, filed on Mar. 18, 2011.

(51) Int. Cl. G06F 9/30

(52) U.S. Cl. CPC G06F 9/30058
USPC 712/240

(57) ABSTRACT

A multicore processor system includes plural CPUs; branch prediction memories respectively disposed for the CPUs; and a shared branch prediction memory that stores branch prediction information records respectively corresponding to threads executed by the CPUs. A first CPU among the CPUs is configured to set the branch prediction information record corresponding to a first thread among the threads executed by the first CPU, from the shared branch prediction memory to the branch prediction memory corresponding to the first CPU.

### CROSS REFERENCE TO RELATED APPLICATIONS

This application is a continuation application of International Application PCT/JP2011/056659, filed on Mar. 18, 2011 and designating the U.S., the entire contents of which are incorporated herein by reference.

### FIELD

The embodiments discussed herein are related to a multicore processor system that predicts a result of a branch instruction, and a branch predicting method.

### BACKGROUND

Devices employing a form of a multicore processor system having a multiple cores in one system are increasing. A multicore processor system divides an application program (hereinafter referred to as an “app”) into multiple threads for parallel execution by the multiple cores, thereby enabling higher-speed processing as compared to the case of executing a process by a single core. A program is executed in units of threads. A technique of finely dividing a thread processing amount and using fine-grained parallelism has been disclosed as a method of further enhancing parallel thread processing performance.

Concerning techniques to increase core speed, pipeline processing has been disclosed that involves division into stages such as fetch, interpretation, and execution executed by a core with one instruction so as to execute the stages in a pipeline manner. Pipeline processing enables the cores to execute multiple instructions at the same time by staggering the stages to improve processing performance.

However, when instructions are executed by pipeline processing, if cores read a branch instruction causing a subsequent instruction to change depending on the result of a preceding instruction, the cores cannot determine the instruction to be executed next. In this case, the cores stop the pipeline and wait until the branch instruction is completed, which reduces processing performance.

To avoid reductions in processing performance due to such a branch instruction, a branch prediction technique has been disclosed for predicting branch direction. By applying the branch prediction technique to predict an instruction to be executed next before completion of a branch instruction, drops in processing performance can be prevented if the prediction is correct. The branch prediction technique can broadly be classified into static branch prediction and dynamic branch prediction. Static branch prediction is a method of predicting branch direction by describing hints of branch directions in a program and by referring to the hints at the time of execution. Dynamic branch prediction is a method of predicting branch direction by retaining information of past branch history, individual branch destinations, and branch frequencies (hereinafter referred to as branch prediction information) in the memory of a core and by referring to the branch prediction information at the time of execution.

For example, a disclosed technique of performing the dynamic branch prediction is, for example, a technique of performing the branch prediction by using past branch history for a given branch instruction and branch history corresponding to a branch instruction group executed before the current time point. A disclosed technique of improving accuracy of the dynamic branch prediction is, for example, a technique of allowing multiple threads executed by multiple cores to refer to the branch prediction information of a different thread executed by another core from each thread (see, e.g., Japanese Laid-Open Patent Publication Nos. H9-244891 and 2006-53830).

However, in the conventional techniques described above, the branch prediction information retained in the dynamic branch prediction is retained in memory included in the core. Since the capacity of the memory is limited, the core deletes older branch prediction information, less frequently referenced branch prediction information, etc., from a branch prediction information group and overwrites the information with new branch prediction information. The accuracy of dynamic branch prediction is poor and processing performance drops consequent to dynamic branch prediction of a branch instruction not being executed a sufficient number of times in the past.

Therefore, if each core performs parallel processing with fine-grained parallelism, the number of process steps per thread is reduced and the total number of types is increased when threads executing the same process or correlated processes are considered as threads of one type. As described above, the dynamic branch prediction by fine-grained parallel processing has a problem of drops in the accuracy of the branch prediction and in processing performance because of the smaller number of executions per branch instruction. In the dynamic branch prediction by fine-grained parallel processing, instruction strings without correlation are successively executed because of the increased total number of types. Therefore, the branch prediction information is successively overwritten, resulting in a problem of drops in the accuracy of the branch prediction.

### SUMMARY

According to an aspect of an embodiment, a multicore processor system includes plural CPUs; branch prediction memories respectively disposed for the CPUs; and a shared branch prediction memory that stores branch prediction information records respectively corresponding to threads executed by the CPUs. A first CPU among the CPUs is configured to set the branch prediction information record corresponding to a first thread among the threads executed by the first CPU, from the shared branch prediction memory to the branch prediction memory corresponding to the first CPU.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of operation of a multicore processor system 100 according to a first embodiment;

FIG. 2 is a block diagram of a hardware configuration of a multicore processor system according to the first embodiment;

FIG. 3 is a block diagram of functions of the multicore processor system 100;

FIG. 4 is a block diagram of software of the multicore processor system 100;

FIG. 5 is an explanatory view of an example of storage contents of an independent branch prediction table 302;

FIG. 6 is an explanatory view of an example of storage contents of a shared branch prediction table 304;

FIG. 7 is an explanatory view of a setting method of a thread type identifier;

FIG. 8 is a sequence diagram when the multicore processor system 100 performs normal operation;

FIG. 9 is a sequence diagram when the multicore processor system 100 performs interrupt operation;

FIG. 10 is a flowchart of a thread activation process;

FIG. 11 is a flowchart of a thread operation termination process;

FIG. 12 is a block diagram of hardware of the multicore processor system 100 according to a second embodiment;

FIG. 13 is a block diagram of hardware of the multicore processor system 100 according to a third embodiment;

FIG. 14 is a flowchart (part 1) of a thread activation process according to the third embodiment;

FIG. 15 is a flowchart (part 2) of the start of thread assignment according to the third embodiment;

FIG. 16 is a flowchart of the thread operation termination process according to the third embodiment;

FIG. 17 is a block diagram of hardware of the multicore processor system 100 according to a fourth embodiment; and

FIG. 18 is an explanatory view of an example of storage contents of a shared branch prediction table 1701 according to the fourth embodiment.

### DESCRIPTION OF EMBODIMENTS

First to fourth embodiments of a multicore processor system, a branch predicting method, and a branch predicting program will be described in detail with reference to the accompanying drawings.

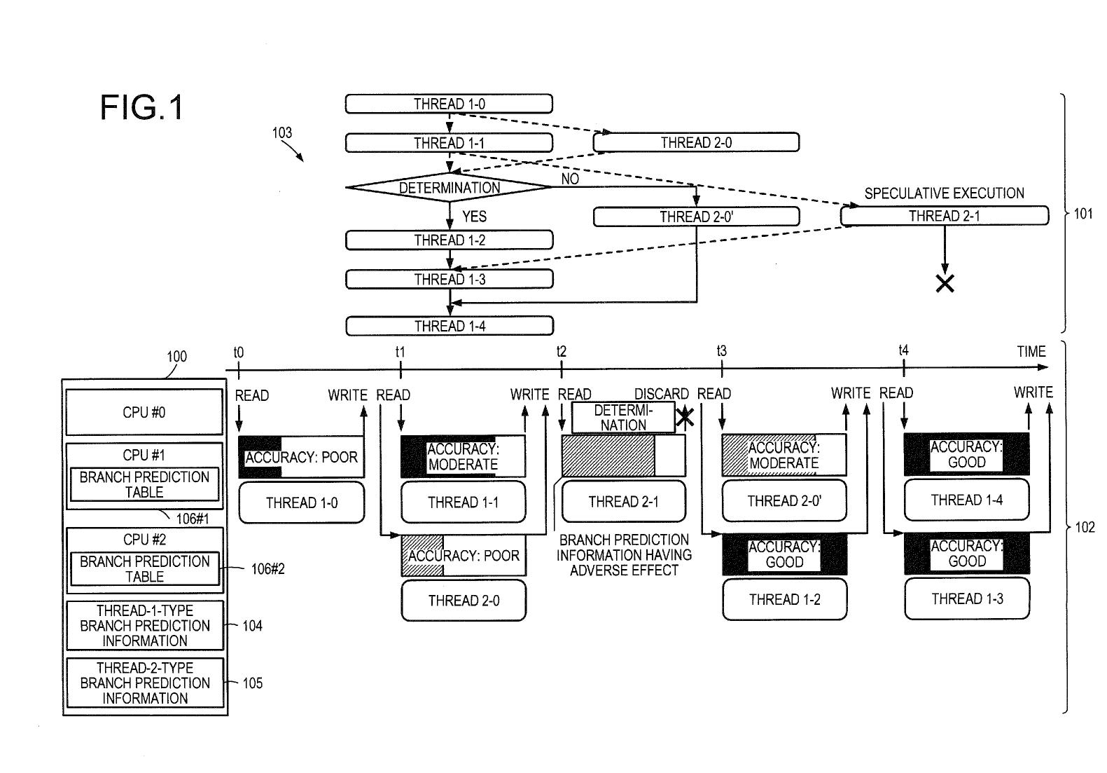

FIG. 1 is an explanatory view of operation of a multicore processor system 100 according to the first embodiment. A portion denoted by reference numeral 101 depicts an example of threads executed in an app 103. A portion denoted by reference numeral 102 depicts a state of branch prediction accuracy in the threads executed in the app 103.

The app 103 executes a thread 1-0, a thread 1-1, a thread 1-2, a thread 1-3, a thread 1-4, a thread 2-0, a thread 2-0′, and a thread 2-1. The threads 1-0 to 1-4 are processes correlated with each other and are of a thread type referred to as a thread-1 type. Similarly, the threads 2-0 to 2-1 are processes correlated with each other and are of a thread type referred to as a thread-2 type. The threads belonging to the thread-1 type have no correlation with the threads belonging to the thread-2 type.

With regard to processing order of the threads, the app 103 issues an execution request for the thread 1-0. The app 103 then issues an execution request for the thread 1-1 and the thread 2-0 utilizing a result of the thread 1-0. The app 103 then makes a determination by using a result of the thread 1-1 and a result of the thread 2-0. If the determination result is YES, the app 103 executes the thread 1-2 and the thread 2-1. The thread 2-1 utilizes a result of the thread 1-1 and does not utilize a result of the thread 2-0. Therefore, the thread 2-1 may be executed speculatively at the end of the thread 1-1 without waiting for the determination.

After the termination of the threads 1-2 and 2-1, the app 103 issues an execution request for the thread 1-3 utilizing a result of the thread 1-2 and a result of the thread 2-1 and, after the termination of the thread 1-3, the app 103 issues an execution request for the thread 1-4 utilizing a result of the thread 1-3.

If the determination result is NO, the app 103 issues an execution request for the thread 2-0′ and issues an execution request for the thread 1-4 that utilizes a result of the thread 2-0′. If the determination result is NO, the app 103 does not utilize the result of the thread 2-1.

The portion denoted by reference numeral 102 depicts a state of branch prediction accuracy in the threads executed in the app 103. The multicore processor system 100 includes CPUs #0 to #2 and also includes thread-1-type branch prediction information 104 and thread-2-type branch prediction information 105. At the time point of time to, storage contents of the thread-1-type branch prediction information 104 and storage contents of the thread-2-type branch prediction information 105 have initial values. The CPU #1 and the CPU #2 respectively include a branch prediction table 106#1 and a branch prediction table 106#2 that stores branch prediction information.

At time t0, in response to the activation start of the thread 1-0, the CPU #0 reads the thread-1-type branch prediction information 104 for writing into the branch prediction table 106#1 of the CPU #1 executing the thread 1-0. From time t0 to time t1, the CPU #1 executes the thread 1-0 belonging to the thread-1 type and accumulates a branch result of a branch instruction used as the branch prediction information in the branch prediction table 106#1. When the thread 1-0 is completed at time t1 and the operation is terminated, the CPU #1 writes the branch prediction information accumulated in the branch prediction table 106#1 into the thread-1-type branch prediction information 104.

Subsequently, if a thread belonging to the thread-1 type is activated and started, the CPU #0 reads the thread-1-type branch prediction information 104 for writing into the branch prediction table 106. Similarly, if a thread belonging to the thread-2 type is activated and started, the CPU #0 reads the thread-2-type branch prediction information 105 for writing into the branch prediction table 106.

Time t0 and time t1 are assumed to have a short time interval therebetween and a small amount of the branch prediction information is accumulated. In the example of FIG. 1, it is assumed that the CPU #1 executes a branch instruction about ⅓ the number of times corresponding to good branch prediction accuracy. Therefore, the accuracy is poor for the branch prediction associated with execution of the thread 1-0 at time t1.

At time t1, in response to the activation start of the thread 1-1, the CPU #0 reads the thread-1-type branch prediction information 104 for writing into the branch prediction table 106#1 of the CPU #1 executing the thread 1-1. Similarly, in response to the activation start of the thread 2-0, the CPU #0 reads the thread-2-type branch prediction information 105 for writing into the branch prediction table 106#2 of the CPU #2 executing the thread 2-0.

From time t1 to time t2, the branch prediction information of the thread 1 is accumulated in the branch prediction table 106#1 and the branch prediction information of the thread 2 is accumulated in the branch prediction table 106#2. Since the branch prediction table 106#1 includes the branch prediction information accumulated between time t0 and time t1, the branch prediction information is accumulated for about ⅔ the number of times corresponding to good branch prediction accuracy in total, resulting in moderate accuracy of the branch prediction. The branch prediction information accumulated between time t0 and time t1 is accumulated in the branch prediction table 106#2, for about ⅓ the number of times corresponding to good branch prediction accuracy, resulting in poor accuracy of the branch prediction.

At time t2, the CPU #1 speculatively executes the thread 2-1. The CPU #0 makes a determination by using the results of the threads 1-1 and 2-0. In the portion denoted by reference numeral 102, the determination result of NO eliminates the need for a result of the thread 2-1 and therefore, the CPU #0 interrupts the speculative execution of the thread 2-1. The thread 2-1 is a thread that is basically not executed unless speculative execution is performed, and the branch prediction information accumulated due to speculative execution adversely affects the other information. Therefore, the CPU #0 discards the branch prediction information accumulated due to the thread 2-1.

From time t3 to time t4, the branch prediction information of the thread 2 is accumulated in the branch prediction table 106#1 and the branch prediction information of the thread 1 is accumulated in the branch prediction table 106#2. Since the branch prediction table 106#1 includes the branch prediction information accumulated between time t1 and time t2, the branch prediction information is accumulated for about ⅔ the number of times corresponding to good branch prediction accuracy in total, resulting in moderate accuracy of the branch prediction. The branch prediction information is accumulated in the branch prediction table 106#2 along with the already accumulated branch prediction information up to the number of times corresponding to good branch prediction accuracy, resulting in good accuracy of the branch prediction.

At time t4, the CPU #0 reads the thread-1-type branch prediction information 104 for the branch prediction table 106#1 and the branch prediction table 106#2. Since the branch prediction information has been sufficiently accumulated as the thread-1-type branch prediction information 104 at time t4, the CPU #1 and the CPU #2 are able to execute the thread 1-3 and the thread 1-4 at high speed.

As described above, the multicore processor system 100 according to the first embodiment has a history of branch prediction results for each thread, sets the corresponding history each time a core executes a thread, and recovers the history after termination. As a result, the multicore processor system 100 is able to accumulate the history and improve the prediction accuracy even if threads are finely grained and immediately terminated. Hardware and software of the multicore processor system 100 for implementing the operation described in FIG. 1 will hereinafter be described.

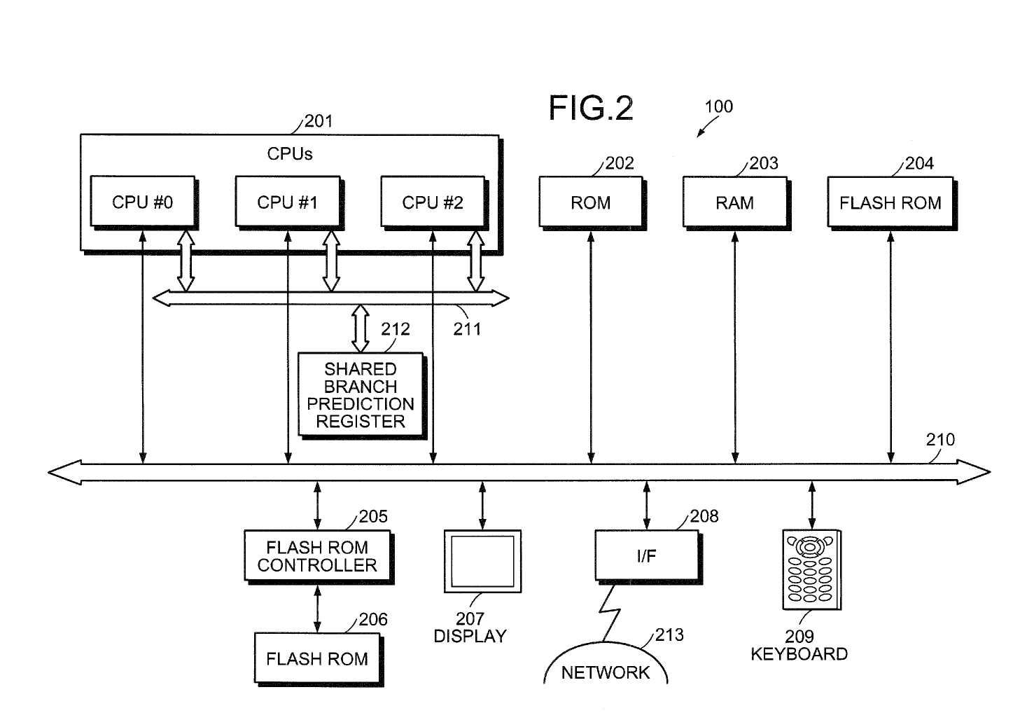

FIG. 2 is a block diagram of a hardware configuration of a multicore processor system according to the first embodiment. As depicted in FIG. 2, the multicore processor system 100 includes multiple central processing units (CPUs) 201, read-only memory (ROM) 202, random access memory (RAM) 203, flash ROM 204, a flash ROM controller 205, and flash ROM 206. The multicore processor system 100 includes a display 207, an interface (I/F) 208, and a keyboard 209, as input/output devices for the user and other devices. The components of the multicore system 100 are respectively connected by a bus 120.

The CPUs 201 govern overall control of the multicore processor system 100. The CPUs 201 refer to CPUs that are single core processors connected in parallel. The CPUs 201 include the CPUs #0 to #2. Further, the CPUs 201 may include at least 2 or more CPUs. The CPUs #0 to #2 respectively have dedicated cache memory. The multicore processor system 100 is a system of computers that include processors equipped with multiple processors. The multiple cores may be provided as a single processor equipped with multiple cores or a group of single-core processors connected in parallel. In the present embodiments, description will be given taking parallel CPUs that are single core processors as an example.

The CPUs #0 to #2 can access a shared branch prediction register 212 through a branch prediction information bus 211. The shared branch prediction register 212 stores the branch prediction information shared and utilized by the CPUs #0 to #2.

The ROM 202 stores programs such as a boot program. The RAM 203 is used as a work area of the CPUs 201. The flash ROM 204 enables high-speed reading and, for example, is NOR-type flash memory. The flash ROM 204 stores system software such as an operating system (OS), and application software. For example, when the OS is updated, the multicore processor system 100 receives a new OS via the I/F 208 and updates the old OS that is stored in the flash ROM 204, with the received new OS.

The flash ROM controller 205, under the control of the CPUs 201, controls the reading and writing of data with respect to the flash ROM 206. The flash ROM 206 has a primary purpose of data storage and portability; and is, for example, NAND-type flash memory. The flash ROM 206 stores data written under control of the flash ROM controller 205. Examples of the data include image data and video data acquired by the user of the multicore processor system through the I/F 208. A memory card, SD card and the like may be adopted as the flash ROM 206.

The display 207 displays, for example, data such as text, images, functional information, etc., in addition to a cursor, icons, and/or tool boxes. A thin-film-transistor (TFT) liquid crystal display and the like may be employed as the display 207.

The I/F 208 is connected to a network 213 such as a local area network (LAN), a wide area network (WAN), and the Internet through a communication line and is connected to other apparatuses through the network 213. The I/F 208 administers an internal interface with the network 111 and controls the input and output of data with respect to external apparatuses. For example, a modem or a LAN adaptor may be employed as the I/F 208.

The keyboard 209 includes, for example, keys for inputting letters, numerals, and various instructions and performs the input of data. Alternatively, a touch-panel-type input pad or numeric keypad, etc. may be adopted.

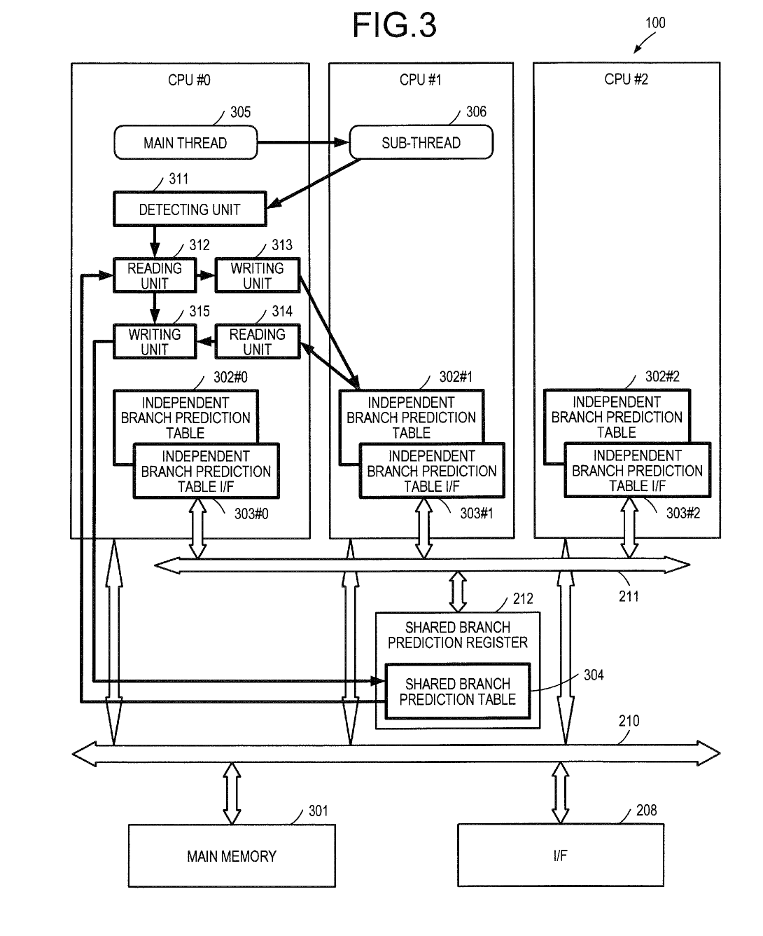

Functions of the multicore processor system 100 will be described. FIG. 3 is a block diagram of the functions of the multicore processor system 100. The multicore processor system 100 includes a detecting unit 311, a reading unit 312, a writing unit 313, a reading unit 314, and a writing unit 315. The functions (the detecting unit 311 to the writing unit 315) forming a control unit are implemented by executing programs stored in a storage device by the CPUs 201. The storage device is the ROM 202, the RAM 203, the flash ROM 204, and the flash ROM 206 depicted in FIG. 2, for example. Although the detecting unit 311 to the writing unit 315 are depicted as functions of the CPU #0 acting as a master CPU in FIG. 3, the units may be functions of the CPU #1 or the CPU #2.

The multicore processor system 100 accesses main memory 301, an independent branch prediction table 302, and a shared branch prediction table 304. When accessing the independent branch prediction table 302 of another CPU, the CPUs #0 to #2 access the table through an independent branch prediction table I/F 303. In FIG. 3, the CPU #0 executes a main thread 305. An execution request of the main thread 305 causes the CPU #1 to execute a sub-thread 306.

The main memory 301 is a main storage device accessed by the CPUs 201. For example, the main memory 301 may be the entire RAM 203 or a portion of the RAM 203.

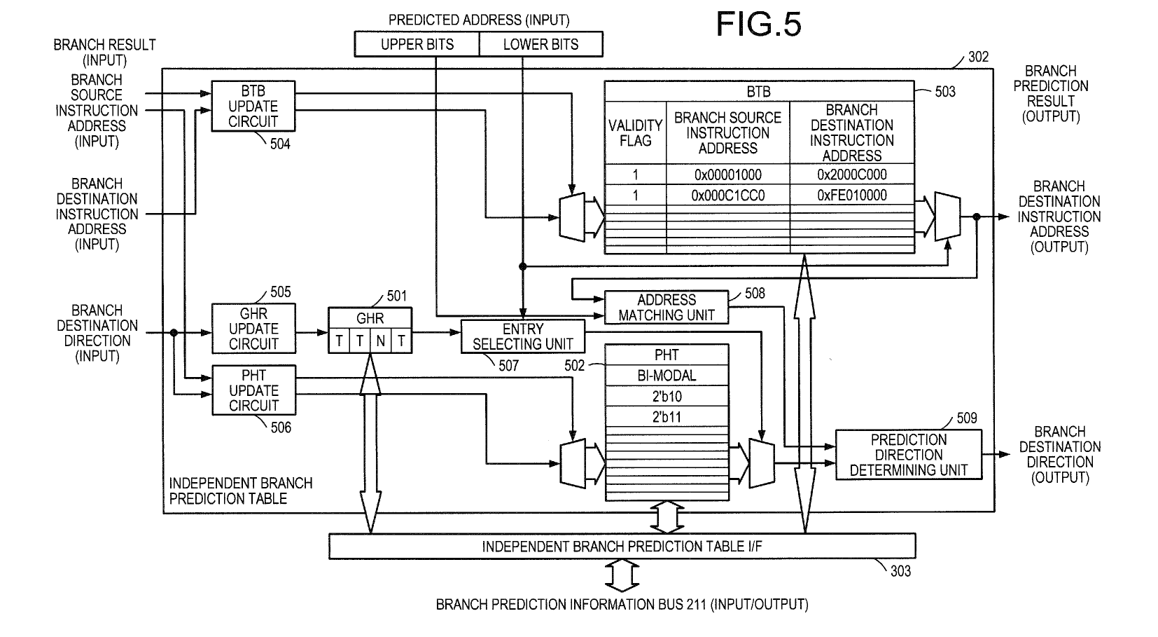

The independent branch prediction table 302 stores branch prediction information accessed by a dynamic branch prediction mechanism. The dynamic branch prediction mechanism is, for example, a Bi-Modal system, a G-Share system, a perceptron branch prediction system, or a system acquired by combining the systems described above. Details of the independent branch prediction table 302 will be described later with reference to FIG. 5. The independent branch prediction table 302 is included in, and stored in a register of, each of the CPUs #0 to #2.

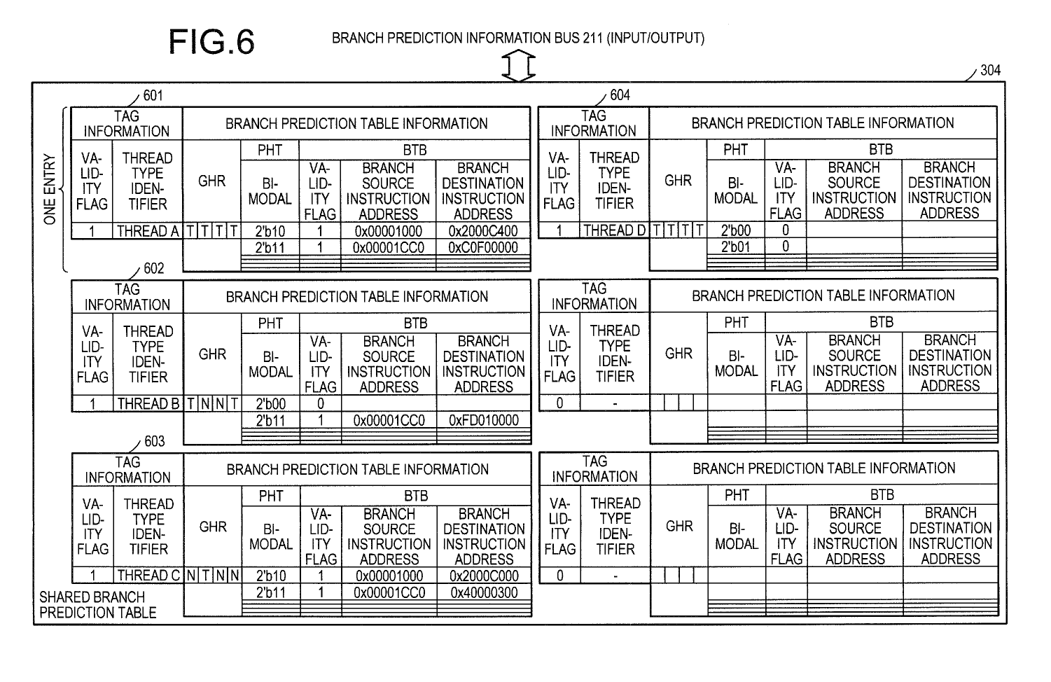

The independent branch prediction table I/F 303 is an I/F making the branch prediction information in the independent branch prediction table 302 included in each CPU readable and writable from outside of the CPU. The shared branch prediction table 304 is a table that stores the branch prediction information for each thread type. Details of the shared branch prediction table 304 will be described later with reference to FIG. 6.

The detecting unit 311 has a function of detecting that a first thread among multiple threads is executed by a first CPU among multiple CPUs. The detecting unit 311 may detect that the operation of the first thread is terminated. For example, the detecting unit 311 detects that the sub-thread 306 is executed by the CPU #1. Information indicative of execution of a given thread is stored in the register of the CPU #0, a cache memory, the main memory 301, etc.

The reading unit 312 has a function of reading the branch prediction information corresponding to the first thread detected by the detecting unit 311, from memory storing the history of branch prediction shared by the CPUs. For example, the reading unit 312 reads the branch prediction information corresponding to the sub-thread 306 from the shared branch prediction table 304.

If the branch prediction information corresponding to the first thread does not exist in the memory storing the history of branch prediction shared by the CPUs, the reading unit 312 may clear the area in which no branch prediction information is stored, and may read the cleared area as the branch prediction information corresponding to the first thread. The read branch prediction information is stored to the register of the CPU #0, the cache memory, etc.

The writing unit 313 has a function of writing the branch prediction information read by the reading unit 312 into memory storing the history of branch prediction corresponding to the first CPU. For example, the writing unit 313 writes the branch prediction information into an independent branch prediction table 302#1 of the CPU #1. Information indicative of execution of the writing may be stored to the register of the CPU #0, the cache memory, the main memory 301, etc.

The reading unit 314 has a function of reading the branch prediction information in the memory storing the history of branch prediction corresponding to the first CPU after termination of the operation of the first thread. For example, the reading unit 314 reads the branch prediction information in the independent branch prediction table 302#1 of the CPU #1 after termination of the execution of the sub-thread 306. The read branch prediction information is stored to the register of the CPU #0, the cache memory, etc.

The writing unit 315 has a function of writing the branch prediction information read by the reading unit 312 into the memory storing the history of branch prediction shared by the CPUs. For example, the writing unit 315 writes the read branch prediction information into the shared branch prediction table 304. Information indicative of execution of the writing may be stored to the register of the CPU #0, the cache memory, the main memory 301, etc.

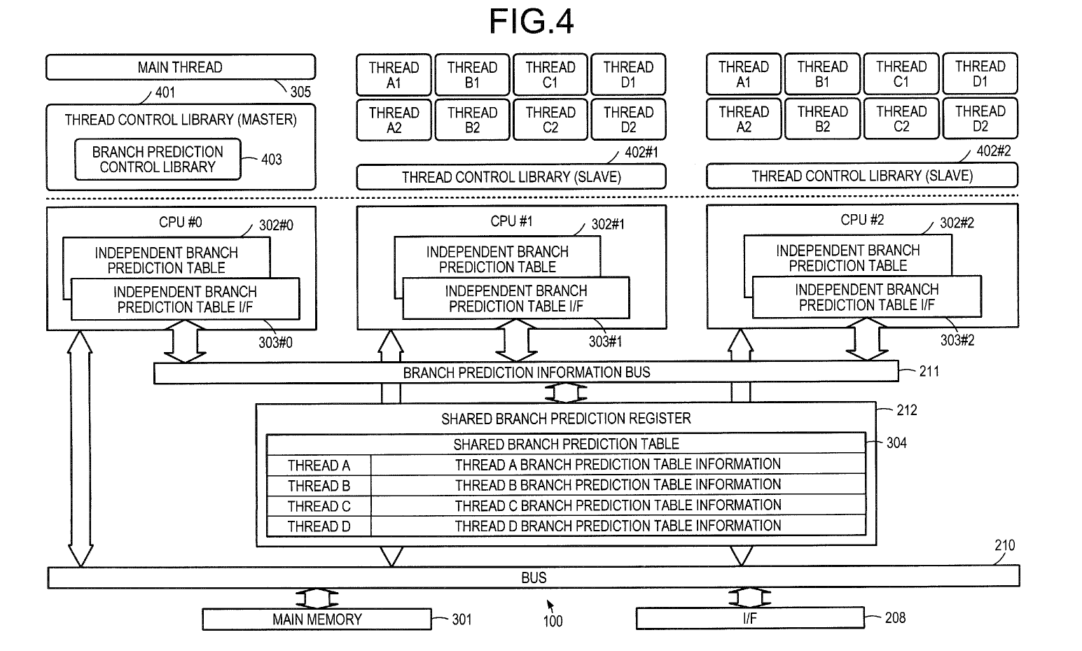

FIG. 4 is a block diagram of software of the multicore processor system 100. The multicore processor system 100 of FIG. 4 executes a thread control library (master) 401, a thread control library (slave) 402#1, and a thread control library (slave) 402#2. The multicore processor system 100 also executes a branch prediction control library 403.

The multicore processor system 100 executes the main thread 305, and a thread A1, a thread A2, a thread B1, a thread B2, a thread C1, a thread C2, a thread D1, and a thread D2 according to a request of the main thread 305. The thread A1 and the thread A2 belong to the same thread type, thread A. Similarly, the thread B1 and the thread B2 belong to the same thread type, thread B; the thread C1 and the thread C2 belong to the same thread type, thread C; and the thread D1 and the thread D2 belong to the same thread type, thread D.

The CPU #0 executes the thread control library (master) 401, the branch prediction control library 403, and the main thread 305. The CPU #1 executes the threads A1 to D2 according to a thread activation request made via the thread control library (master) 401 and the thread control library (slave) 402#1 by the main thread 305. The CPU #2 also executes the threads A1 to D2 according to a thread activation request made via the thread control library (master) 401 and the thread control library (slave) 402#2.

As described above, the multicore processor system 100 has a form of asymmetric multiprocessing (AMP), which is frequently employed in an embedded system and involves assigning a given thread to a CPU core. The multicore processor system 100 may have a form of symmetric multiprocessing (SMP) in which CPUs are treated equally.

The thread control library (master) 401 and the thread control library (slave) 402 have a function of causing a thread to be executed after scheduling based on the thread activation request from the main thread 305. For example, the thread control library (master) 401 notifies the thread control library (slave) 402 to cause the thread A1 to be executed after scheduling based on the thread activation request from the main thread 305. The notified thread control library (slave) 402 causes the CPU #1 to execute the thread A1.

The thread control library (master) 401 and the thread control library (slave) 402 have a function of notifying the main thread 305 of completion of operation of a thread at the timing of termination of the operation of the thread. For example, if the operation of the thread A1 is terminated, the thread control library (slave) 402 notifies the thread control library (master) 401. The notified thread control library (master) 401 notifies the main thread 305 of the termination of the operation of the thread.

The branch prediction control library 403 has a function of accessing the shared branch prediction table 304 and transferring the branch prediction information at the timing of the thread activation of the thread control library (master) 401 and the termination of the thread operation of the thread control library (slave) 402. For example, if the thread A1 is activated, the branch prediction control library 403 accesses the shared branch prediction table 304 and transfers the branch prediction table information corresponding to the thread A to the CPU #1.

FIG. 5 is an explanatory view of an example of storage contents of the independent branch prediction table 302. The independent branch prediction table 302 includes a global history register (GHR) 501, a pattern history table (PHT) 502, and a branch target buffer (BTB) 503. The independent branch prediction table 302 includes a BTB update circuit 504, a GHR update circuit 505, a PHT update circuit 506, an entry selecting unit 507, an address matching unit 508, and a prediction direction determining unit 509 as circuits and functional units operating the GHR 501 to the BTB 503. The independent branch prediction table I/F 303 updates the GHR 501 to the BTB 503 serving as the branch prediction information.

The GHR 501 is a register storing information that indicates whether past several branch instructions are established. An identifier indicative of the time of establishment of a branch instruction is set to “T” if established and to “N” if not established. For example, the GHR 501 stores establishment results of the past four branch instructions, which are established, established, not established, and established.

The PHT 502 is a table having a saturation counter of several bits, etc., to represent whether a branch instruction tends to be established or not established. The possible values of the PHT 502 are “2′b10” indicative of a large possibility of not branching, “2′b01” indicative of a small possibility of not branching, “2′b10” indicative of a small possibility of branching, and “2′b11” indicative of a large possibility of branching. In this case, “2′b” indicates that a value is a binary number.

The BTB 503 is a buffer storing a branch destination address for each branch instruction. The BTB 503 includes three fields of validity flag, branch source instruction address, and branch destination instruction address. The validity flag field stores a value indicative of whether the corresponding record is valid. For example, if the validity flag field has “1”, this indicates that the corresponding record is valid. If the validity flag field has “0”, this indicates that the corresponding record is invalid. The branch source instruction address field stores an address acting as a branch instruction. The branch destination instruction address field stores a branch destination address in the case of branching.

The BTB update circuit 504 is a circuit the updates the BTB 503 based on the branch source instruction address and the branch destination instruction address. For example, the BTB update circuit 504 uses lower bits of the branch source instruction address to select a record of the BTB 503 and sets the validation flag, the branch source instruction address, and the branch destination instruction address.

The GHR update circuit 505 is a circuit that updates the GHR 501 based on branch destination direction. For example, the GHR update circuit 505 receives one [bit] information indicative of establishment or no-establishment of a branch instruction from the branch destination direction and sets the GHR 501.

The PHT update circuit 506 is a circuit that updates the PHT 502 based on the branch source instruction address and the branch destination direction. For example, the PHT update circuit 506 uses lower bits of the branch source instruction address to select a record of the PHT 502 and changes a counter in the PHT 502. In particular, the PHT update circuit 506 increments the counter if the branch destination direction is information indicative of establishment of a branch and decrements the counter if the branch destination direction is information indicative of no-establishment of a branch.

The entry selecting unit 507 has a function of selecting a record of the PHT 502 based on lower bits of a predicted address and the GHR 501. For example, the entry selecting unit 507 combines the bit string of the GHR 501 to the lower bits of the predicted address to generate data such that a record of the PHT 502 can uniquely be selected. The entry selecting unit 507 may calculate XOR of the lower bits of the predicted address and the bit string of the GHR 501 as the data such that a record of the PHT 502 can uniquely be selected.

The address matching unit 508 determines whether higher bits of the predicted address match the branch source instruction address. If matching, the address matching unit 508 outputs a signal indicative of the matching of the addresses.

The prediction direction determining unit 509 has a function of determining whether a branch instruction corresponding to the predicted address branches. For example, if the signal indicative of the matching of the addresses is received from the address matching unit 508 and the record selected by the entry selecting unit 507 has a possibility of branching, the prediction direction determining unit 509 determines that a branch is established and outputs a branch destination direction.

With the functions described above, if the predicted address is input to the independent branch prediction table 302, the independent branch prediction table 302 outputs whether a branch is established, by using the branch destination direction, or outputs the branch destination instruction address.

FIG. 6 is an explanatory view of an example of storage contents of the shared branch prediction table 304. The shared branch prediction table 304 includes two fields of tag information and branch prediction table information. The tag information field further includes two fields of validity flag and thread type identifier. The validity flag field stores a value indicating whether the corresponding branch prediction information is valid. For example, if the validity flag field has “1”, this indicates that the branch prediction information is valid.

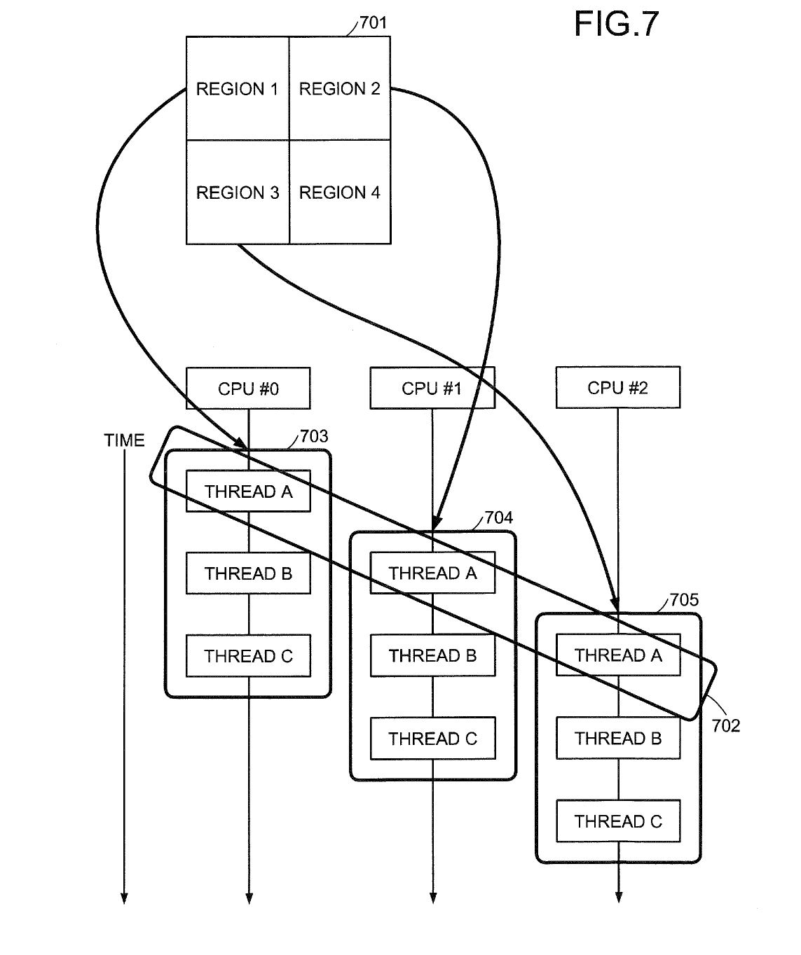

The thread type identifier field stores information identifying the thread type. For the information identifying the thread type is information capable of uniquely identifying a thread such as an initial address of an instruction string may be defined as a thread type. The thread type identifier may be set as an identifier common to correlated threads. A specific setting method of the thread type identifier will be described later with reference to FIG. 7.

The branch prediction table information is information including three fields of a GHR field corresponding to the GHR 501 depicted in FIG. 5, a PHT field corresponding to the PHT 502, and a BTB field corresponding to the BTB 503. The storage contents of the fields of the branch prediction table information are equivalent to the GHR 501 to the BTB 503 described with reference to FIG. 5 and therefore will not be described.

The tag information and the branch prediction table information corresponding to one thread are hereinafter collectively referred to as one entry of the shared branch prediction table 304. For example, the shared branch prediction table 304 depicted in FIG. 6 has a total of four entries registered as entries 601 to 604.

For example, the entry 601 has the thread type identifier of a thread A and has the branch prediction table information indicative of establishment of all the branches registered in the GHR field and two records “2′b10” and “2′b11” registered in the PHT field. The entry 601 also has two records registered in the BTB field. The two records include a record having of a branch source instruction address “0x00001000” and a branch destination instruction address “0x2000C400” and a record having of a branch source instruction address “0x00001CC0” and a branch destination instruction address “0xC0F00000”.

The entry 602 has the thread type identifier of a thread B and has the branch prediction table information indicative of establishment, no-establishment, non-establishment, and establishment of branches registered in the GHR field and two records “2′b00” and “2′b11” registered in the PHT field. The entry 602 also has one record registered in the BTB field. The one record is a record having of a branch source instruction address “0x00001CC0” and a branch destination instruction address “0xFD010000”.

The entry 603 has the thread type identifier of a thread C and has the branch prediction table information indicative of no-establishment, establishment, non-establishment, and no-establishment of branches registered in the GHR field and two records “2′b10” and “2′b11” registered in the PHT field. The entry 603 also has two records registered in the BTB field. The two records include a record having of a branch source instruction address “0x00001000” and a branch destination instruction address “0x20000000” and a record having of a branch source instruction address “0x00001CC0” and a branch destination instruction address “0x40000300”.

The entry 604 has the thread type identifier of a thread D and has the branch prediction table information indicative of establishment of all the branches registered in the GHR field and two records “2′b00” and “2′b01” registered in the PHT field. The entry 604 has no valid record in the BTB field.

FIG. 7 is an explanatory view of a setting method of the thread type identifier. In FIG. 7, description will be made of the setting method of the thread type identifier when the multicore processor system 100 performs image processing. It is assumed that the multicore processor system 100 executes a given process for an image 701. The given process may be any process such as color compensation and hue/saturation conversion, for example.

The multicore processor system 100 divides an image 701 into regions 1 to 4 for processing. For the divided regions, the CPU #0 executes a thread belonging to the thread-A type, a thread belonging to the thread-B type, a thread belonging to the thread-C type in this order for the region 1. Hereinafter, for simplicity of description, it is assumed that the respective executed threads are a thread A1, a thread B1, and a thread C1. Similarly, the thread A1, the thread B1, and the thread C1 are executed in this order for the region 2 by the CPU #1 and for the region 3 by the CPU #2.

In this case, if the thread type identifier of a given entry is set to the thread-A type, the given entry is accessed by threads belonging to a group 702. If the thread type identifier of a given entry is set to an identifier indicative of the region 1, the given entry is accessed by threads belonging to a group 703. The identifier indicative of the region 1 is an initial address of the region 1, a file pointer on a file system, etc.

Similarly, if the thread type identifier of a given entry is set to an identifier indicative of the region 2, the given entry is accessed by threads belonging to a group 704. If the thread type identifier of a given entry is set to an identifier indicative of the region 3, the given entry is accessed by threads belonging to a group 705.

As described above, when the thread type identifier is set to an identifier related to data, if a result of a branch instruction changes depending on classification of the data, the multicore processor system 100 can improve the prediction accuracy.

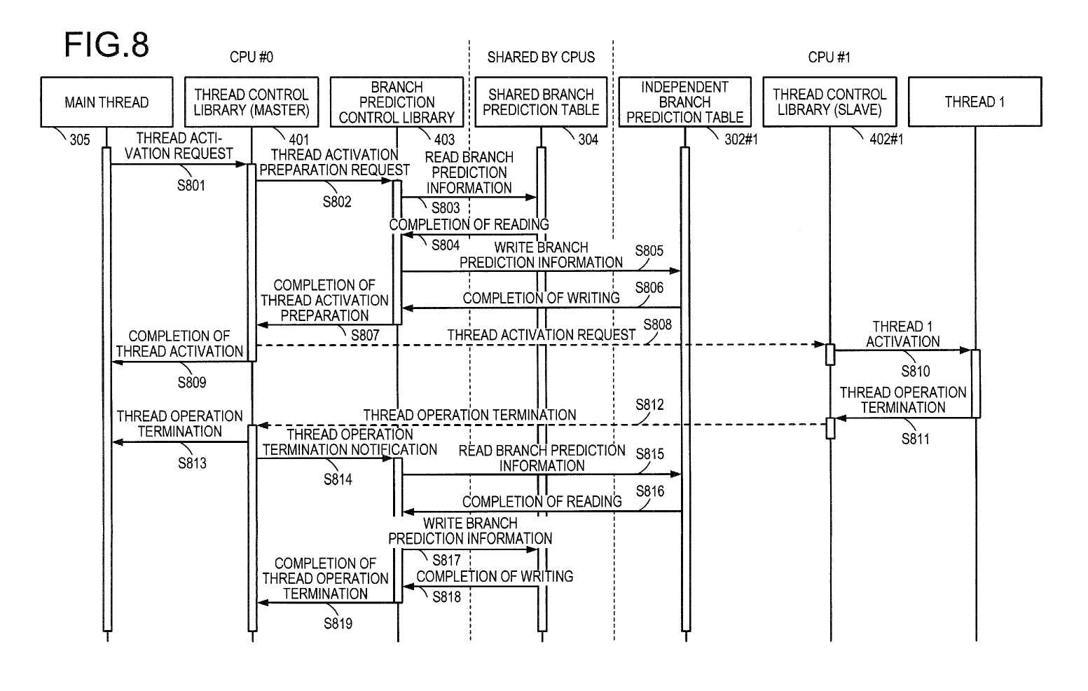

FIG. 8 is a sequence diagram when the multicore processor system 100 performs normal operation. In FIG. 8, the CPU #0 executes the main thread 305, the thread control library (master) 401, and the branch prediction control library 403. The CPU #1 accesses the independent branch prediction table 302#1 and executes the thread control library (slave) 402 and the thread 1.

The main thread 305 notifies the thread control library (master) 401 of a thread activation request (step S801). The notified thread control library (master) 401 further notifies the branch prediction control library 403 of a thread activation preparation request (step S802).

The branch prediction control library 403 receiving the thread activation preparation request uses the thread type identifier corresponding to the activation request to read branch prediction information from the shared branch prediction table 304 (step S803). After completion of the reading (step S804), the branch prediction control library 403 writes the read branch prediction information into the independent branch prediction table 302#1 (step S805). After completion of the writing (step S806), the branch prediction control library 403 notifies the thread control library (master) 401 of the completion of thread activation preparation (step S807).

The thread control library (master) 401 receiving the completion of the thread activation preparation notifies the thread control library (slave) 402#1 of a thread activation request (step S808) and notifies the main thread 305 of the completion of the thread activation (step S809).

The thread control library (slave) 402 receiving the thread activation request activates the thread 1 in the CPU #1 (step S810). The CPU #1 accesses the independent branch prediction table 302#1 to perform branch prediction during execution of the thread 1.

When the operation of the thread 1 is terminated, the thread control library (slave) 402 receives the thread operation termination (step S811) and notifies the thread control library (master) 401 of the thread operation termination (step S812).

The thread control library (master) 401 receiving the thread operation termination notifies the main thread of the thread operation termination (step S813) while notifying the branch prediction control library 403 of a thread operation termination notification (step S814). The notified branch prediction control library 403 reads the branch prediction information from the independent branch prediction table 302#1 (step S815).

After completion of the reading (step S816), the branch prediction control library 403 writes the read branch prediction information into the shared branch prediction table 304 (step S817). After completion of the writing (step S818), the branch prediction control library 403 notifies the thread control library (master) 401 of the completion of the thread operation termination (step S819).

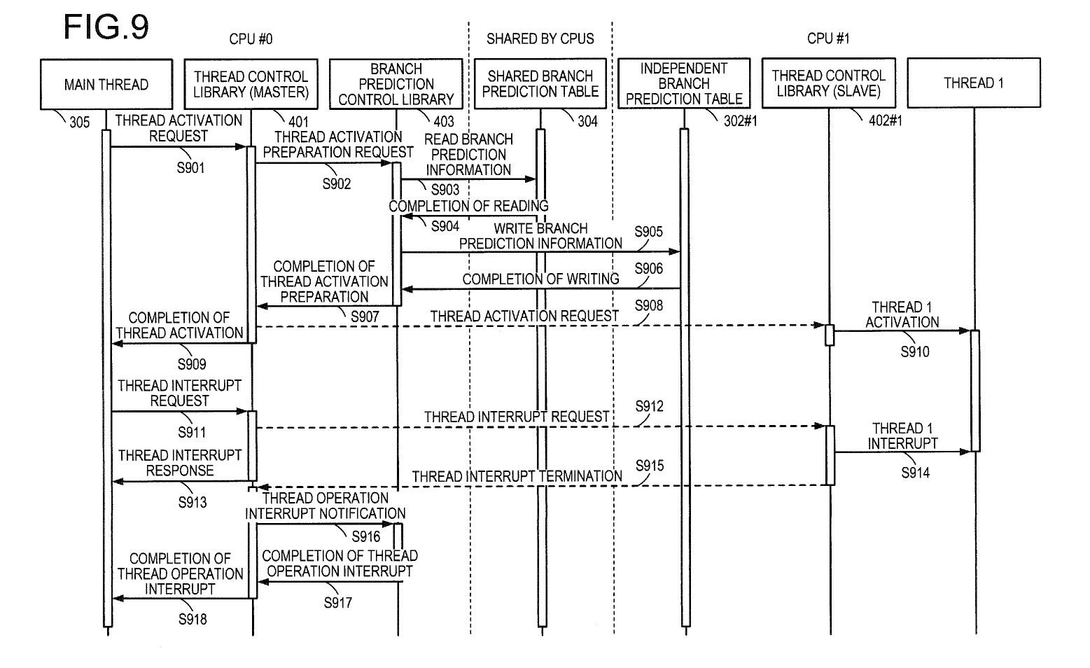

FIG. 9 is a sequence diagram when the multicore processor system 100 performs interrupt operation. In the sequence diagram of the interrupt operation depicted in FIG. 9, the sequence indicated by steps S901 to S910 is the same as the sequence indicated by steps S801 to S810 and therefore will not be described.

The main thread 305 notifies the thread control library (master) 401 of a thread interrupt request (step S911). The notified thread control library (master) 401 notifies the thread control library (slave) 402#1 of the thread interrupt request (step S912) and notifies the main thread 305 of a thread interrupt response (step S913).

The thread control library (slave) 402#1 receiving the thread interrupt request, interrupts the thread 1 (step S914) and notifies the thread control library (master) 401 of the termination of the thread interrupt (step S915). The thread control library (master) 401 receiving notification of thread interrupt termination, gives thread operation interrupt notification (step S916). The branch prediction control library 403 receiving the thread operation interrupt notification notifies the thread control library (master) 401 of the completion of the thread operation interrupt, without updating the shared branch prediction table 304 (step S917). The thread control library (master) 401 receiving notification of the completion of the thread operation interrupt, notifies the main thread 305 of the completion of the thread operation interrupt (step S918).

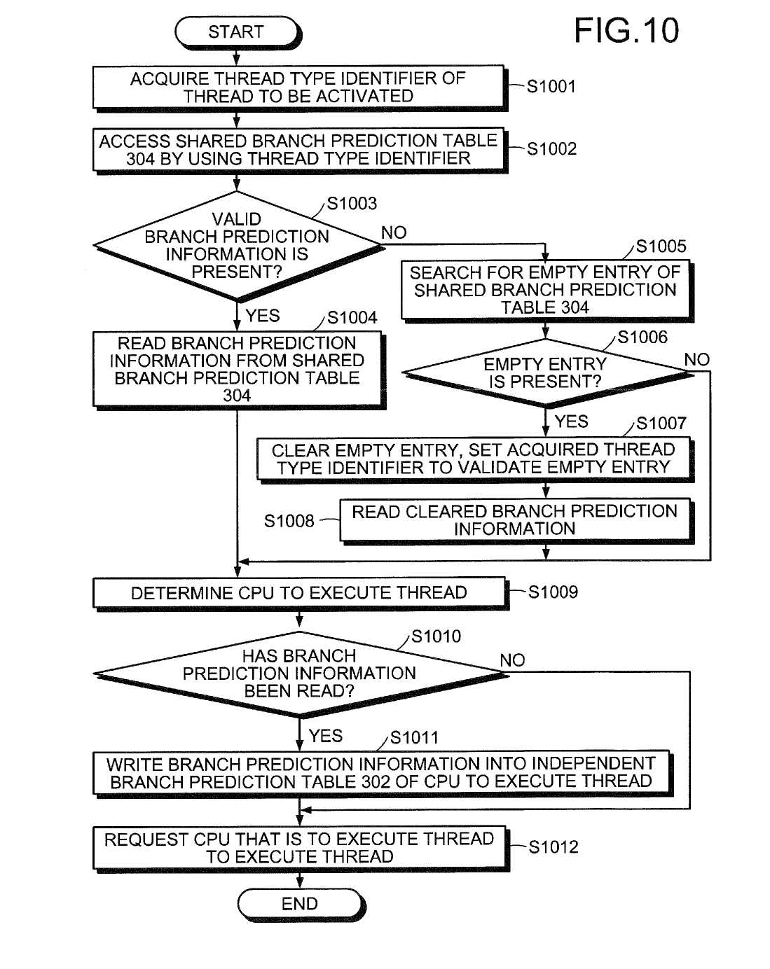

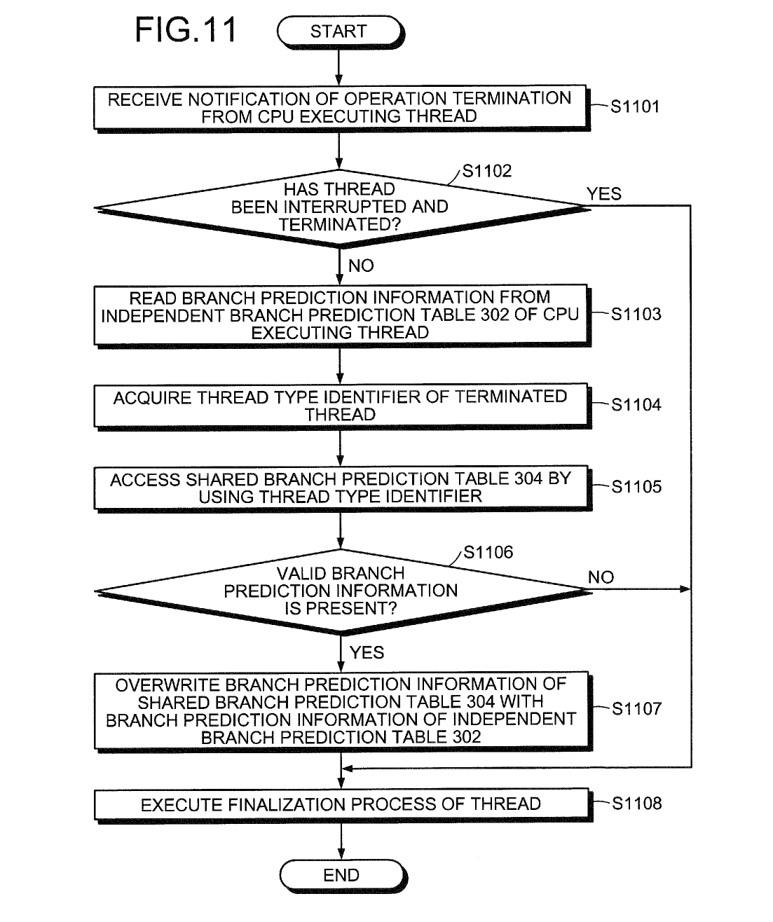

Processes of the branch prediction control library 403 satisfying the operation of the sequence diagrams depicted in FIGS. 8 and 9 will be described with reference to FIGS. 10 and 11. FIG. 10 is a flowchart of a thread activation process and FIG. 11 is a flowchart of a thread operation termination process. The thread operation termination process occurs if a process of a thread is completed and if a process of a thread is interrupted and terminated.

FIG. 10 is a flowchart of the thread activation process. The CPU #0 acquires a thread type identifier of a thread to be activated (step S1001). After the acquisition, the CPU #0 accesses the shared branch prediction table 304 by using the thread type identifier (step S1002), and determines whether valid branch prediction information is present (step S1003). If valid branch prediction information is present (step S1003: YES), the CPU #0 reads the branch prediction information from the shared branch prediction table 304 (step S1004).

If no valid branch prediction information is present (step S1003: NO), the CPU #0 searches for an empty entry of the shared branch prediction table 304 (step S1005). The empty entry refers to an entry with the validity flag of “0”. After the search, the CPU #0 determines whether an empty entry is present (step S1006). If an empty entry is present (step S1006: YES), the CPU #0 clears the empty entry, sets the acquired thread type identifier to validate the empty entry (step S1007), and reads the cleared branch prediction information (step S1008).

Clearing of an entry is, for example, to put a prediction result of branch prediction information into a neutral state. For example, the CPU #0 sets the PHT 502 to non-branching (small possibility). The clearing of an entry may be performed by clearing a prediction result according to specifications of the independent branch prediction table 302.

If no empty entry is present (step S1006: NO), or after completion of step S1004 or S1008, the CPU #0 determines a CPU to execute the thread (step S1009). With regard to a method of determining a CPU to execute the thread, the CPU is determined by a function included in a scheduler of an OS, etc.

After the determination, the CPU #0 determines whether the branch prediction information has been read (step S1010). If the branch prediction information has been read (step S1010: YES), the CPU #0 writes the branch prediction information into the independent branch prediction table 302 of the CPU to execute the thread (step S1011). After the writing, or if the branch prediction information has not been read (step S1010: NO), the CPU #0 requests the CPU that is to execute the thread to execute the thread (step S1012), and ends the thread activation process.

The thread activation process is generated by the scheduling function of the OS for a thread after switching when the switch is made to another thread. In this case, the CPU #0 executes the operation at step S1001 as “acquisition of the thread type identifier of the switched thread”. The thread activation process may be executed for a switched thread after switching of a thread occurring when a time slice allocated to the thread expires. The thread activation process may be executed for a thread after returning from interrupt by an interrupt service routine (ISR).

FIG. 11 is a flowchart of the thread operation termination process. The CPU #0 receives notification of operation termination from the CPU executing the thread (step S1101). After receiving the notification, the CPU #0 determines whether the thread is interrupted and terminated (step S1102). If the thread is terminated without interruption (step S1102: NO), the CPU #0 reads the branch prediction information from the independent branch prediction table 302 of the CPU executing the thread (step S1103). After the reading, the CPU #0 acquires the thread type identifier of the terminated thread (step S1104).

After the acquisition, the CPU #0 accesses the shared branch prediction table 304 by using the thread type identifier (step S1105), and determines whether valid branch prediction information is present (step S1106). If valid branch prediction information is present (step S1006: YES), the CPU #0 overwrites the branch prediction information of the shared branch prediction table 304 with the branch prediction information of the independent branch prediction table 302 (step S1107). After the overwriting, or if no valid branch prediction information is present (step S1106: NO), or if the thread is interrupted and terminated (step S1102: YES), the CPU #0 executes a finalization process of the thread (step S1108). After the execution, the CPU #0 ends the thread operation termination process.

The thread operation termination process arises consequent to the scheduling function of the OS for a thread before switching when a switch is made to another thread. In this case, the CPU #0 executes the operation at step S1101 as “notification of switching of a thread from the CPU executing the thread” and the operation at step S1104 as “acquisition of the thread type identifier of the thread before switching”. The CPU #0 does not execute the operation at step S1108.

As described above, according to the multicore processor system and the branch predicting method, the history of the branch prediction result is kept for each thread and, each time a core executes a thread, the corresponding history is set in memory storing history of branch prediction in the core and is recovered when the thread is terminated. As a result, the multicore processor system can accumulate the history and improve the prediction accuracy even if parallel processing is finely grained and threads are immediately terminated.

If a speculatively executed thread is interrupted, the multicore processor system may discard the history of branch prediction accumulated by the speculatively executed thread. As a result, the multicore processor system is able to avoid mixing the history of branch prediction from a thread that need not be executed and the currently accumulated history of the branch prediction result; and is able to accumulate more accurate history of the branch prediction result.

The multicore processor system may have a bus that transfers the branch prediction information from the memory storing the history of branch prediction shared by the CPUs to the memory storing the history of branch prediction, in each CPU. As a result, the multicore processor system is able to transfer the branch prediction information without being inhibited by the transfer of another data.

If the branch prediction information corresponding to the thread is not present in the memory storing the history of branch prediction shared by the CPUs, the multicore processor system may clear the area in which no branch prediction information is stored, and may read the area as the branch prediction information corresponding to the thread. As a result, the multicore processor system is able to effectively utilize empty areas.

The multicore processor system is able to maintain the accuracy of the branch prediction even when the threads are finely grained. For example, it is assumed that a given core executes a fine-grained thread while another core executes a fine-grained thread. In the conventional technique, the other core cannot refer to the branch prediction information of the fine-grained thread executed by the given core, which deteriorates the prediction accuracy. In the first embodiment, the other core is able to refer to the branch prediction information of the fine-grained thread executed by the given core, and the prediction accuracy is improved.

If the size of the shared branch prediction table is N times greater than the size of the independent branch prediction table included in each core, the multicore processor system is able to realize the same branch prediction accuracy as when the memory for branch prediction information retained by a core is multiplied by N in the conventional technique. Since the memory used for the shared branch prediction table is less frequently accessed as compared to the memory for branch prediction information retained by a core, lower-speed memory can be used and cost can be reduced.

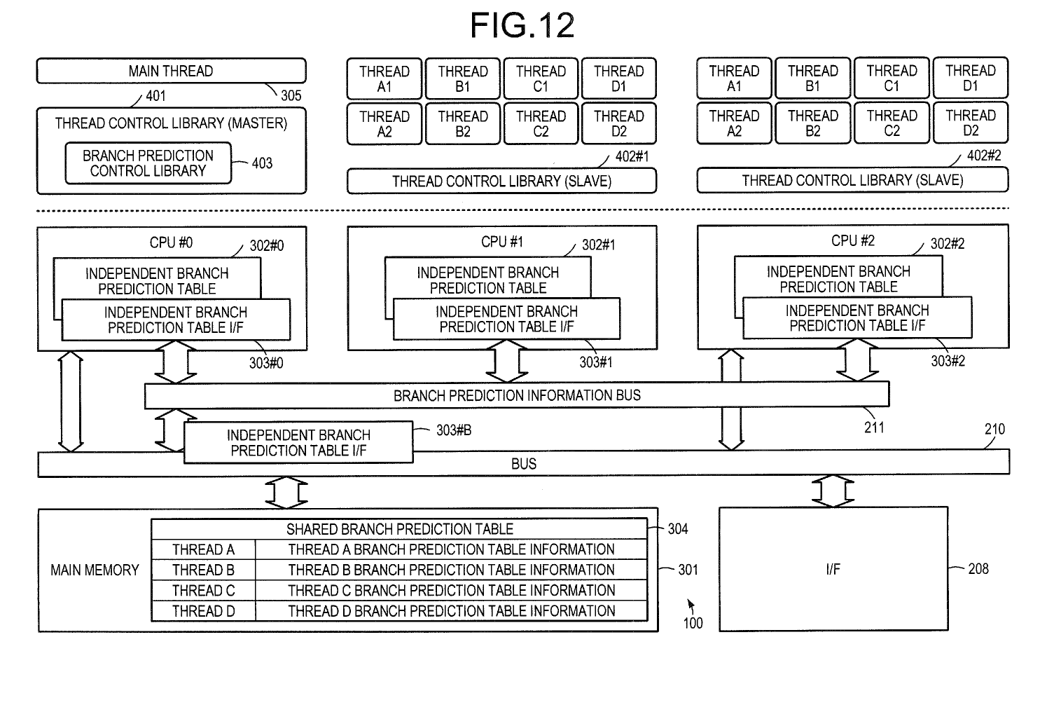

FIG. 12 is a block diagram of hardware of the multicore processor system 100 according to the second embodiment. In the multicore processor system 100 according to the second embodiment, the storage location of the shared branch prediction table 304 is different from the hardware of the multicore processor system 100 according to the first embodiment. The multicore processor system 100 according to the second embodiment has the same hardware and the same functions as the multicore processor system 100 according to the first embodiment except the storage location of the shared branch prediction table 304 and therefore will not be described.

The multicore processor system 100 according to the second embodiment stores the shared branch prediction table 304 in the main memory 301. The independent branch prediction table 302 is mapped on an I/O space and is accessed by the CPUs. The branch prediction information bus 211 and a bus 210 are connected by an independent branch prediction table I/F 303#B. For example, the CPU #0 accesses the shared branch prediction table 304 via an independent branch prediction table I/F 303#0 and the independent branch prediction table I/F 303#B.

At the time of activation of a thread, the branch prediction control library 403 reads the branch prediction information of the thread to be activated, from the shared branch prediction table 304 on the main memory 301. The branch prediction control library 403 then writes the shared branch prediction table 304 into the independent branch prediction table 302 of the CPU executing the thread on the I/O space. Therefore, additional cost of hardware can be reduced as compared to the multicore processor system 100 according to the first embodiment. In the multicore processor system 100 according to the second embodiment, if the main memory 301 has a free area, it is not necessary to add a storage element storing the shared branch prediction table 304.

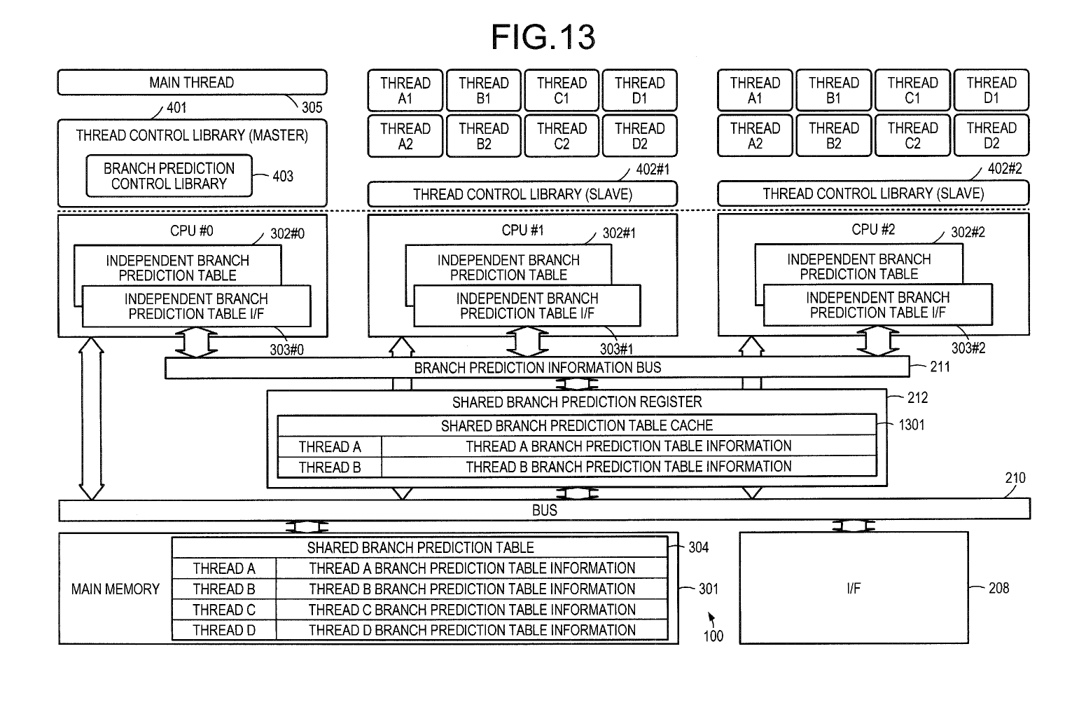

FIG. 13 is a block diagram of hardware of the multicore processor system 100 according to the third embodiment. In the multicore processor system 100 according to the third embodiment, the storage location of the shared branch prediction table 304 is the main memory 301 and a portion thereof is stored as a shared branch prediction table cache 1301 in the branch prediction register 212. The shared branch prediction table cache 1301 has the same fields as the shared branch prediction table 304. The multicore processor system 100 according to the third embodiment has the same hardware and the same functions as the multicore processor system 100 according to the first embodiment except the storage location of the shared branch prediction table 304 and therefore will not be described.

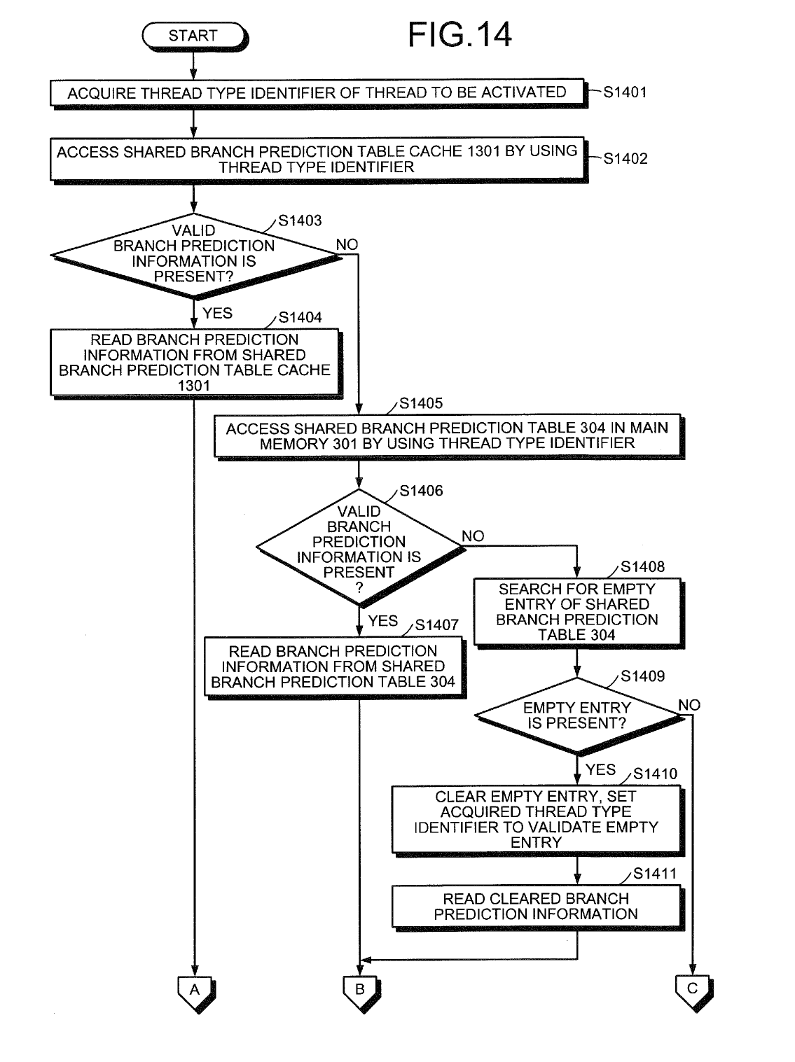

FIG. 14 is a flowchart (part 1) of a thread activation process according to the third embodiment. In the thread activation process according to the third embodiment, steps S1406 to S1411 are equivalent to steps S1003 to S1008 depicted in FIG. 10 and therefore will not be described except after the operation at step S1409: NO.

The CPU #0 acquires a thread type identifier of a thread to be activated (step S1401). After the acquisition, the CPU #0 accesses the shared branch prediction table cache 1301 by using the thread type identifier (step S1402). As a result of the access, the CPU #0 determines whether valid branch prediction information is present (step S1403). If valid branch prediction information is present (step S1403: YES), the CPU #0 reads the branch prediction information from the shared branch prediction table cache 1301 (step S1404). After the reading, the CPU #0 goes to the operation at step S1503.

If no valid branch prediction information is present (step S1403: NO), the CPU #0 accesses the shared branch prediction table 304 in the main memory 301 by using the thread type identifier (step S1405). After the end of step S1407 or S1411, the CPU #0 goes to the operation at step S1501. After the operation at step S1409: NO, the CPU #0 goes to the operation at step S1503.

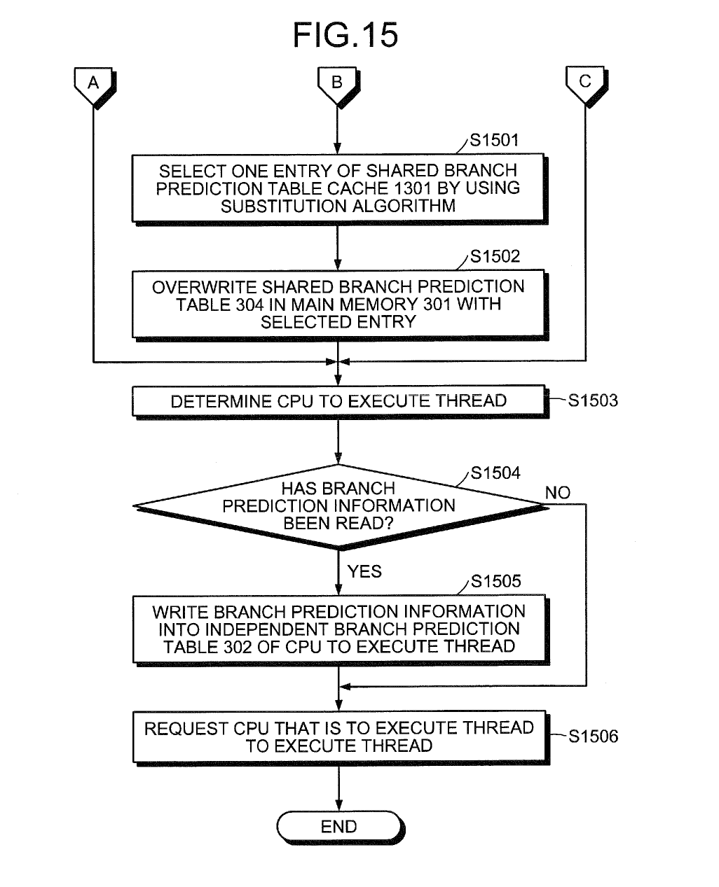

FIG. 15 is a flowchart (part 2) of the start of thread assignment according to the third embodiment. Steps S1503 to S1506 are equivalent to steps S1009 to S1012 depicted in FIG. 10 and therefore will not be described.

The CPU #0 selects one entry of the shared branch prediction table cache 1301 by using substitution algorithm (step S1501). For example, the substitution algorithm may be implemented by applying Least Recently Used (LRU), Least Frequently Used (LFU), etc. After the selection, the CPU #0 overwrites the shared branch prediction table 304 in the main memory 301 with the selected entry (step S1502).

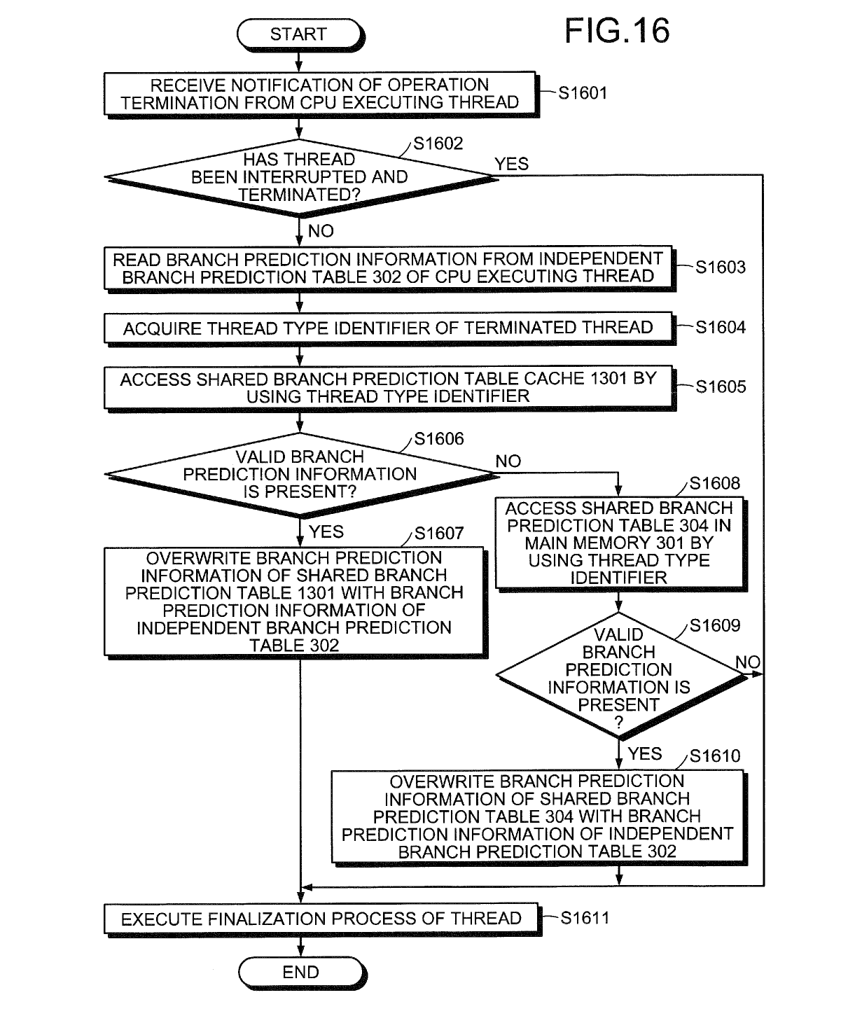

FIG. 16 is a flowchart of the thread operation termination process according to the third embodiment. In the thread operation termination process according to the third embodiment, the operations at steps S1601 to S1604 is equivalent to steps S1101 to S1104 depicted in FIG. 11 and therefore will not be described. Similarly, the operations at steps S1609 to S1611 is equivalent to steps S1106 to S1108 and therefore will not be described.

The CPU #0 accesses the shared branch prediction table cache 1301 by using the thread type identifier (step S1605). After the access, the CPU #0 determines whether valid branch prediction information is present (step S1606). If valid branch prediction information is present (step S1606: YES), the CPU #0 overwrites the branch prediction information of the shared branch prediction table 1301 with the branch prediction information of the independent branch prediction table 302 (step S1607) and goes to the operation at step S1611.

If no valid branch prediction information is present (step S1606: NO), CPU #0 accesses the shared branch prediction table 304 in the main memory 301 by using the thread type identifier (step S1608). After the access, the CPU #0 goes to the operation at step S1609.

As described above, if temporal locality exists in thread activation, the multicore processor system 100 according to the third embodiment can reduce the overhead of performance related to thread activation and thread operation termination.

The multicore processor system 100 according to the first to third embodiments acquires the branch prediction information based on the currently executed thread type. The multicore processor system 100 according to the fourth embodiment acquires the branch prediction information based on past thread activation history.

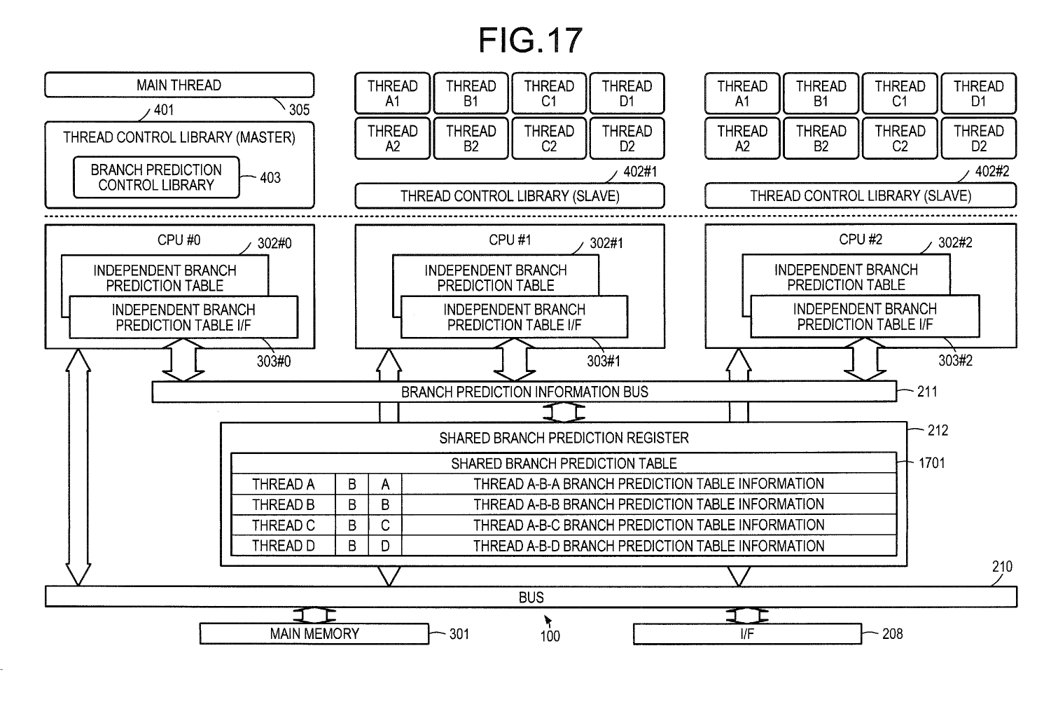

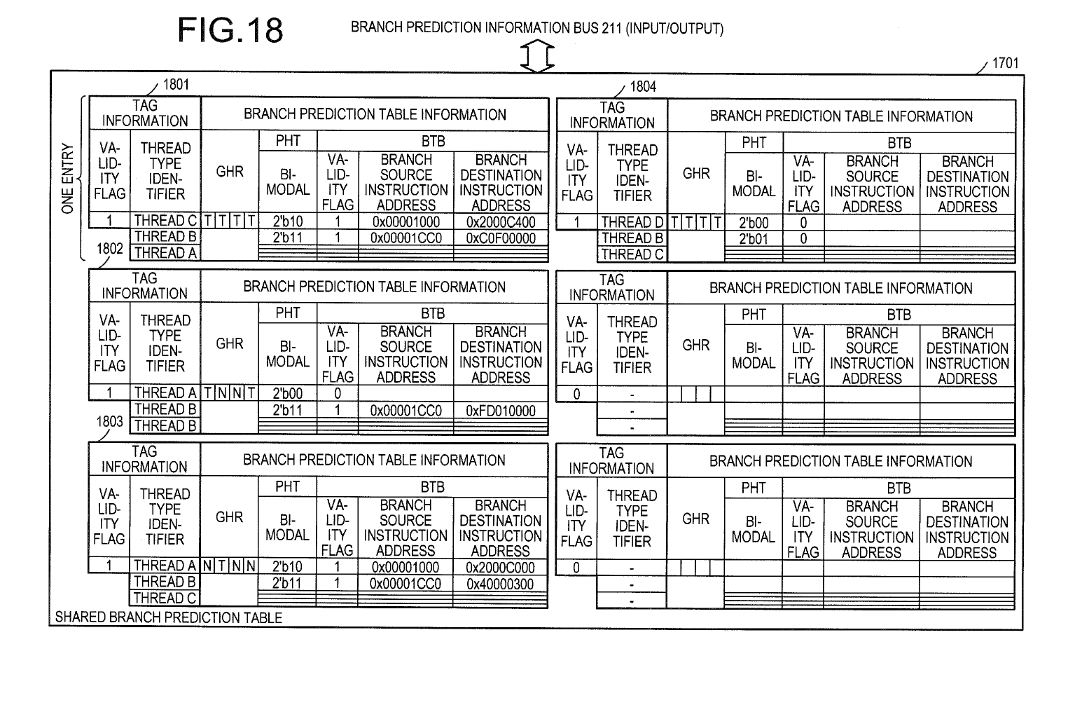

FIG. 17 is a block diagram of hardware of the multicore processor system 100 according to the fourth embodiment. The multicore processor system 100 according to the fourth embodiment includes a shared branch prediction table 1701 instead of the shared branch prediction table 304 according to the first embodiment. Details of the shared branch prediction table 1701 will be described later with reference to FIG. 18. The multicore processor system 100 according to the fourth embodiment is the same as the multicore processor system 100 according to the first embodiment except for the shared branch prediction table 304, has the same functions except for the reading unit 312, and therefore will not be described.

The reading unit 312 reads the branch prediction information corresponding to a first thread detected by the detecting unit 311 and a second thread executed before the first thread, from the memory that stores the history of branch prediction shared by the CPUs.

FIG. 18 is an explanatory view of an example of storage contents of the shared branch prediction table 1701 according to the fourth embodiment. The shared branch prediction table 1701 includes a thread activation order identifier field instead of the thread type identifier of the shared branch prediction table 304. The other fields in the shared branch prediction table 1701 store the same storage contents as the other fields of the shared branch prediction table 304 and therefore will not be described.

The thread activation order identifier field stores thread type identifiers in the order of activation of threads. For example, the thread activation order identifier field of an entry 1801 indicates that the thread type identifier activated this time is the thread A, that a thread of the thread-B type was activated at a previous time, and that a thread of the thread-C type was activated before the previous time. Hereinafter, for simplicity of description, it is assumed that the respective executed threads of the thread types are a thread A1, a thread B1, a thread C1, and a thread D1. Similarly, the thread activation order identifier field of an entry 1802 indicates that the thread activated this time is the thread B1, that the thread B1 was activated at a previous time, and that the thread A1 was activated before the previous time.

The thread activation order identifier field of an entry 1803 indicates that the thread activated this time is the thread C1, that the thread B1 was activated at a previous time, and that the thread A1 was activated before the previous time. Lastly, the thread activation order identifier field of an entry 1804 indicates that the thread activated this time is the thread C1, that the thread B1 was activated at a previous time, and that the thread D1 was activated before the previous time.

As described above, the multicore processor system 100 according to the fourth embodiment accesses the shared branch prediction table 1701 to execute the activation process and the operation termination process of a thread. A specific flowchart can be supported by replacing the thread type identifier with the thread activation order identifier in the flowchart depicted in FIG. 11 and therefore will not be described.

As descried above, the multicore processor system 100 according to the fourth embodiment sets the branch prediction information based on the thread activation order. As a result, the multicore processor system can improve the branch prediction accuracy if correlation exists between the thread activation order and the tendency of individual branches.

The branch predicting method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

An aspect of the present invention produces an effect that the accuracy of the branch prediction can be improved when fine-grained threads of parallel processing are executed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multicore processor system comprising:
a plurality of CPUs;
a plurality of branch prediction memories respectively disposed for the CPUs; and
a shared branch prediction memory that stores branch prediction information records respectively corresponding to threads executed by the CPUs, wherein
a first CPU among the CPUs is configured to set the branch prediction information record corresponding to a first thread among the threads executed by the first CPU, from the shared branch prediction memory to the branch prediction memory corresponding to the first CPU.

2. The multicore processor system according to claim 1, further comprising
a bus that transfers the branch prediction information records from the shared branch prediction memory to the branch prediction memories.

3. The multicore processor system according to claim 1, wherein
the first CPU, at the end of operation of the first thread, writes into the shared branch prediction memory, the branch prediction information record in the branch prediction memory corresponding to the first CPU.

4. The multicore processor system according to claim 1, wherein
the shared branch prediction memory corresponds to a main memory.

5. The multicore processor system according to claim 4, further comprising a shared branch prediction cache that stores at least one of the branch prediction information records that are in the main memory.

6. The multicore processor system according to claim 1, wherein
the branch prediction information record corresponding to the first thread includes information included in the branch prediction information record related to a second thread executed before the first thread.

7. A branch predicting method executed by a first CPU among a plurality of CPUs, the branch predicting method comprising:
writing branch prediction information corresponding to a first thread from a shared branch prediction memory into a branch prediction memory corresponding to the first CPU; and
performing based on the branch prediction information corresponding to the first thread, branch prediction and executing the first thread.

8. The branch predicting method according to claim 7, wherein
the writing includes writing, at the end of operation of the first thread, the branch prediction information in the branch prediction memory corresponding to the first CPU into the shared branch prediction memory.

9. The branch predicting method according to claim 7, further comprising
clearing a table in which no branch prediction information is stored and reading from the table, the branch prediction information corresponding to the first thread, when valid branch prediction information corresponding to the first thread is not present in the shared branch prediction memory.

10. The branch predicting method according to claim 7, wherein
the branch prediction information corresponding to the first thread includes branch prediction information related to a second thread that is executed before the first thread.
